(19) United States
(12) Patent Application Publication
(10) Pub. No.: US 2015/0002660 A1
(43) Pub. Date: Jan. 1, 2015

(54) ELECTRIC PRODUCT

(71) Applicants: Joongkeun Lee, Seoul (KR); Wonchul Choi, Seoul (KR); Soonhaeng Jo, Seoul (KR); Jaehong Kim, Seoul (KR); Seunghoe Choe, Seoul (KR); Hyungsup Kim, Seoul (KR); Sungyup Kim, Seoul (KR)

(72) Inventors: Joongkeun Lee, Seoul (KR); Wonchul Choi, Seoul (KR); Soonhaeng Jo, Seoul (KR); Jaehong Kim, Seoul (KR); Seunghoe Choe, Seoul (KR); Hyungsup Kim, Seoul (KR); Sungyup Kim, Seoul (KR)

(73) Assignee: LG ELECTRONICS INC., Seoul (KR)

(21) Appl. No.: 14/317,942

(22) Filed: Jun. 27, 2014

(30) Foreign Application Priority Data
Jun. 28, 2013 (KR) 10-2013-0075007
Sep. 3, 2013 (KR) 10-2013-0105196

(51) Int. Cl. H04N 5/225; F25D 29/00; F25D 11/00

(52) U.S. Cl. CPC H04N 5/225; F25D 11/00; F25D 29/00
USPC 348/135

(57) ABSTRACT

Provided is an electric product. The electric product includes a main body including at least one food storage unit, at least one camera disposed in the at least one food storage unit to photograph an incoming or outgoing food, and a control unit to determine whether the food is stocked or released on the basis of an image photographed by the at least one camera.

### CROSS-REFERENCE TO RELATED APPLICATION(S)

This application claims priority under 35 U.S.C. §119 to Korean Application No. 10-2013-0075007 filed on Jun. 28, 2013, and Korean Patent Application No. 10-2013-0105196 filed on Sep. 3, 2013, whose entire disclosures are hereby incorporated by reference.

### BACKGROUND

1. Field

This relates to an electric product.

2. Background

An electric product may be an apparatus using electricity as a power source. An example of such an electric product may be, for example, a refrigerator. Such a refrigerator may include a main body defining a storage chamber, and a door for selectively opening and closing the main body. A display for displaying an operation state of the refrigerator and other such information may be provided on the door.

### BRIEF DESCRIPTION OF THE DRAWINGS

The embodiments will be described in detail with reference to the following drawings in which like reference numerals refer to like elements wherein:

FIG. 1 illustrates a network system according to an embodiment.

FIG. 2 is a block diagram of an exemplary refrigerator of the network system shown in FIG. 1.

FIGS. 3A and 3B illustrate an exemplary recognition device installed in the refrigerator shown in FIG. 2.

FIGS. 4A and 4B illustrate an image captured by the recognition device shown in FIG. 3.

FIG. 5 is a flowchart of a method of recognizing an item within the refrigerator, according an embodiment.

FIGS. 6A and 6B illustrate an image captured by a recognition device according to another embodiment.

FIG. 7 illustrates a plurality of recognition devices installed in a refrigerator, according to another embodiment.

FIGS. 8A and 8B illustrate images captured by first and second recognition devices shown in FIG. 7.

FIG. 9 illustrates a plurality of recognition devices installed in a refrigerator, according to another embodiment.

FIGS. 10A and 10B illustrate images captured by first and second recognition devices shown in FIG. 9.

FIG. 11 illustrates a plurality recognition devices installed in a refrigerator, according to another embodiment.

FIGS. 12A and 12B illustrate a recognition device installed in a refrigerator, according to another embodiment.

FIGS. 13A and 13B illustrate images captured by the recognition device shown in FIG. 12.

FIG. 14 illustrates a recognition device installed on one of two opposite sidewalls of a food storage device, according to another embodiment.

FIG. 15 illustrates an exemplary recognition device including a plurality of sensors and a camera installed in a food storage device, according to another embodiment.

### DETAILED DESCRIPTION

Reference will now be made in detail to the embodiments of the present disclosure, examples of which are illustrated in the accompanying drawings.

In the following detailed description, reference is made to the accompanying drawings that form a part hereof, and in which is shown by way of illustration various embodiments. These embodiments are described in sufficient detail to enable those skilled, and it is understood that other embodiments may be utilized and that logical structural, mechanical, electrical, and chemical changes may be made without departing from the spirit or scope as broadly described herein. To avoid detail not necessary to enable those skilled in the art, the description may omit certain information known to those skilled in the art. The following detailed description is, therefore, not to be taken in a limiting sense.

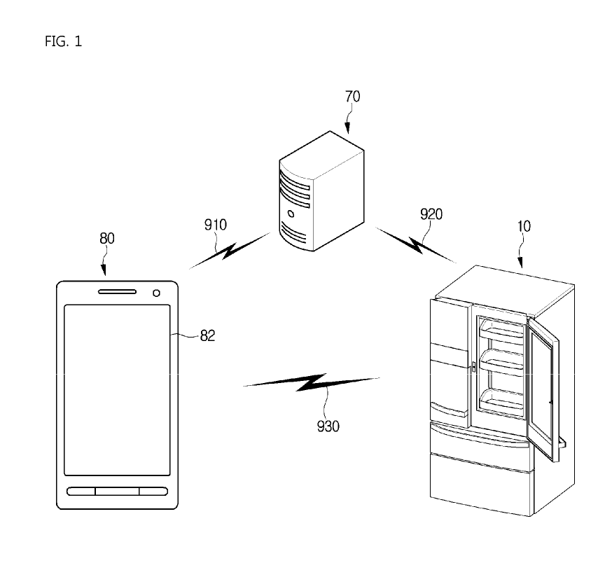

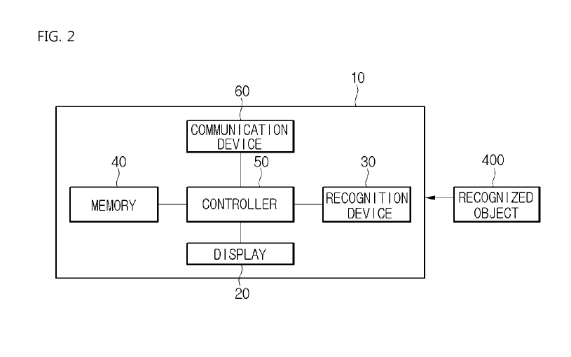

Referring to FIGS. 1 and 2, a network system as embodied and broadly described herein may include a refrigerator 10 generating cool air to store items, for example, food items, in a low-temperature state as an example of an electric product, a terminal 80 communicably connected to the refrigerator 10, and a server 70 communicably connected to the refrigerator 10 and the terminal 80.

The terminal 80 includes a display 82 for displaying predetermined information. Food information or operation state information of the refrigerator 10 may be displayed on the display 82 of the terminal 80. That is, the terminal 80 may monitor a state of the refrigerator 10. Operation of the refrigerator 10 may also be controlled using the terminal 80, and information recognized by the terminal 80 may be transmitted to the refrigerator 10.

For example, the terminal 80 may be a portable mobile phone or a smartphone, but is not limited thereto.

The network system may include a first interface 910 allowing the terminal 80 to communicate with the server 70, a second interface 920 allowing the refrigerator 10 to communicate with the server 70, and a third interface 930 allowing the terminal 80 to communicate with the refrigerator 10.

Each of the first, second and third interfaces 910, 920, and 930 may use at least one of Wifi, Zig-bee, Bluetooth, internet communication or other communication as a communication method for transmitting information, but is not limited thereto.

The refrigerator 10 may include a display 20 for displaying information, a recognition device 30 for recognizing the information, a memory 40 for storing information related to the food, and a communication device 60 for communicating with the server 70 and/or the terminal 80.

The recognition device 30 may include at least one of a camera, an RFID reader, a QR code reader, a bar code reader and the like. Hereinafter, the recognition device 30 including the camera as an example will be described.

The recognition device 30 may acquire an image of an object 400 to be recognized (hereinafter, referred to as a recognized object). For example, the recognized object 400 may include a food item (including food packaging) to be stored in the refrigerator 10.

The information related to the food may include specific information related to the food itself or food management information. The food specific information may include, for example, an image corresponding to the food item and an amount of the food item or a number of the food item. The food management information may include a food name, an image of the food item, a stored position of the food item, a food storage period, an amount of storage food or a stored method of the food, an incoming date, and an outgoing date. The storage period may include, for example, a residual period that is calculated from the incoming date, a closing date for storing, and a storage expiration period from the incoming date to the outgoing date.

Some of the food information may be acquired from the image that is acquired by the recognition device 30.

The food information may be stored in the memory 40. Some or all of the information stored in the memory 40 may be stored in the server 70 or the terminal 80 or loaded into the server 70 or the terminal 80.

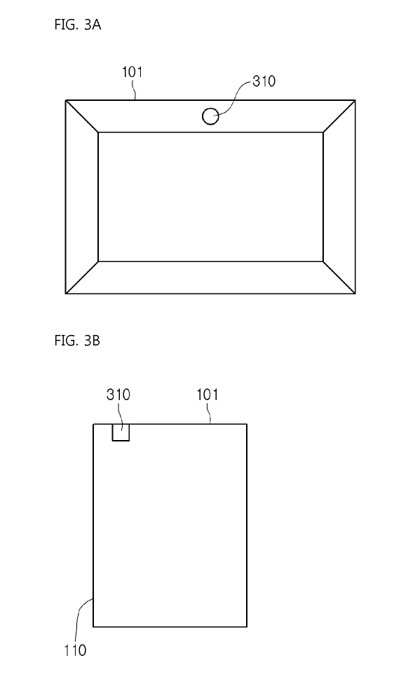

FIGS. 3A and 3B illustrate a recognition device including a camera installed in a refrigerator, according to a first embodiment, in which FIG. 3A is a front view of a food storage device, and FIG. 3B is a side view of the food storage device.

Referring to FIGS. 2 and 3, the refrigerator 10 according to the first embodiment may include a main body including at least one of a refrigerating compartment and a freezing compartment, which store the food. The refrigerating compartment or the freezing compartment may include at least one food storage device 101.

A camera 310 for acquiring an image of the recognized object 400 stored in the food storage device 101 may be provided in the food storage device 101. For example, the camera 310 may be disposed on a top surface of the food storage device 101. Thus, the camera 310 may photograph an object 400 that is disposed in an area below the camera 310.

The camera 310 may be disposed on a front portion of the food storage device 101. That is, the camera 310 may be disposed adjacent to an opening 110 of the food storage device 101.

In general, the food item that is the object 400 to be recognized may be accommodated in the food storage device 101 through the opening 110. As the food item may be stored anywhere within the food storage device 101 and not necessarily accommodated at a front portion, with respect to front and rear directions, of the food storage device 101, the camera 310 may be installed at the front portion of the food storage device 101 to photograph the whole image of the recognized object 400 that is stocked into or removed from the food storage device 101.

The controller 50 may determine a name of the food that is the recognized object 400 based on the image photographed by the camera 310. Also, the controller 50 may determine whether the food is being stocked removed based on the image photographed by the camera 310.

In the current embodiment, the food storage device 101 may be provided in plurality, and a camera 310 may be provided in each of the food storage devices 101. In this case, the controller 50 may recognize a number of the camera 310 that is installed in each particular food storage device 101 and also recognize the stored position of the food that is stocked or removed based on the recognized number of the camera 310.

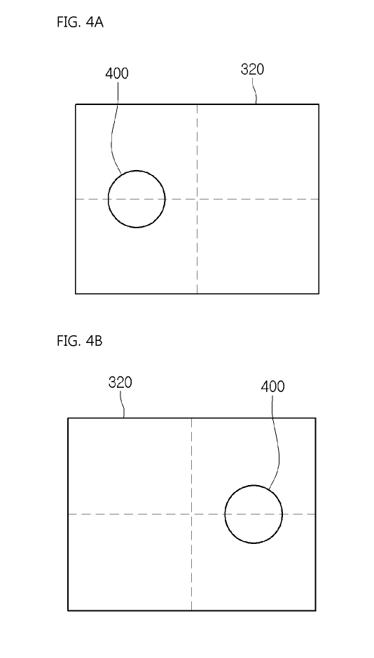

FIG. 4A is a view of a photographed image of incoming food captured by the camera shown in FIGS. 3A-3B, and FIG. 4B is a photographed image of the outgoing food, according to the first embodiment.

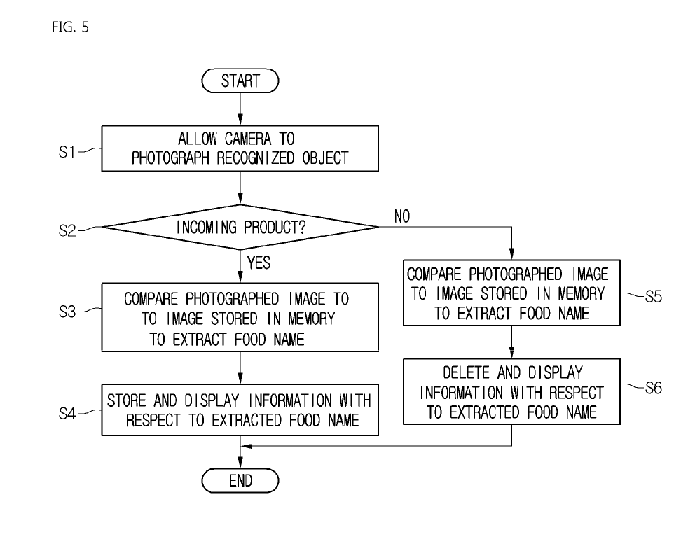

FIG. 5 is a flowchart of a method of recognizing a food item within the refrigerator, according to the first embodiment.

First, the camera 310 provided in the food storage device 101 photographs the recognized object 400 (S1). A user may, for example, place the recognized object 400 on a bottom wall of the food storage device 101 that is disposed adjacent to the opening 110 of the food storage device 101 to photograph the recognized object 400.

The camera 310 may photograph the recognized object 400 when a predetermined time has elapsed after a door for opening and closing the food storage device 101 has removed. Alternatively, the camera 310 may photograph the recognized object 400 in response to a photographing command input by the user. In this case, the photographing command may be performed by a photographing button provided in the food storage device 101. Alternatively, the camera 310 may be turned on when the door is opened. Then, when the recognized object 400 is detected by the camera 310, the camera 310 may perform a photographing operation. The current embodiment is not limited by the photographing start method of the camera 310.

The controller 50 may determine whether the recognized object 400 is being stocked or removed based on the photographed image.

For example, the controller 50 may partition an image 320 photographed by the camera 310 into a plurality of areas. For example, the photographed image 320 may be partitioned in left/right and front/rear directions. In FIG. 4A, a lower portion may represent a front side (that is, an opening-side of the food storage device 110), and an upper portion may represent a rear side of the food storage device 110.

In FIG. 4A, if the recognized object 400 is disposed at a left side with respect to a vertical reference line, the controller 50 may determine that the recognized object 400 corresponds to a stocked food item. On the other hand, if the recognized object 400 is disposed at a right side with respect to the vertical reference line as illustrated in FIG. 4B, the controller 50 may determine that the recognized object 400 corresponds to the released food.

Also, if a left area of the recognized object 400 is greater than a right area thereof with respect to the vertical reference line, the controller 50 may determine that the recognized object 400 corresponds to the stocked food. If a right area of the recognized object 400 is greater than the left area thereof with respect to the vertical reference line, the controller 50 may be determined that the recognized object 400 corresponds to a food to be released.

The standard of determination may be decided by the product itself. Thus, when the food is stocked, an instruction of the product or a guide phrase for putting the incoming food on the left side of the food storage device with respect to the left/right sides of the food storage device may be written on a shelf defining a reception storage part or the bottom wall. Also, when previously stored food items area released, an instruction of the product or a guide phrase for putting the incoming food on the left side of the food storage device with respect to the left/right sides of the food storage unit may be written on the shelf defining a reception storage part or the bottom wall.

In operation S2, if the controller 50 determines that the recognized object 400 corresponds to an incoming food item, the controller 50 extracts the recognized object 400 from the photographed image to compare an image of the extracted recognized object 400 to images stored in the memory 40, thereby determining a food name corresponding to the image of the extracted recognized object 400 (S3).

In another example, the controller 50 may transmit the image of the extracted recognized object 400 to the server 70 and compare the image of the extracted recognized object 400 to images stored in the memory of the server 70 to allow the server 70 to transmit the food name to the controller 50.

Then, the controller 50 may store information with respect to the extracted food name in the memory 40 to display the information with respect to the extracted food name on the display 20 (S4).

For example, the controller 50 may control the memory 40 and the display 20 to store the extracted food name and an image corresponding to the extracted food name, a stored position of the stocked food, an incoming date of the food, a residual period for storing the stocked food, a storage method, and the like in the memory 40, and display at least one of the stored information items on the display 20.

In certain embodiments, the memory unit 40 may include a first memory for storing the specific food information and a second memory for storing the extracted food name (the name of the stocked food).

In operation S2, when the controller 50 determines that the recognized object 400 is a food to be released, the controller 50 may extract the recognized object 400 from the photographed image to compare the image of the extracted recognized object 400 to the images stored in the memory 40 (or memory stored in the server 70), thereby determining a food name corresponding to the image of the extracted recognized object 400 (S5).

Then, the controller 50 may delete the information related to the extracted food name (the name of the released food) from the memory 40 and display the information related to the outgoing food name on the display 20 (S6).

For example, the information related to the released food name is deleted from the second memory, and the image corresponding to the released food name, the stored position of the released food, the incoming date of the food, the residual period for storing the food, and the like may be displayed on the display 20.

When modification of the information with respect to the stocked food and the information with respect to the released food, which are displayed on the display 20, is needed, the user may select the information to be modified and then modify the selected information.

According to the current embodiment, the incoming or outgoing action of the food that is the recognized object 400 may be clearly recognized, and also, a name of the food that is the recognized object may be clearly recognized.

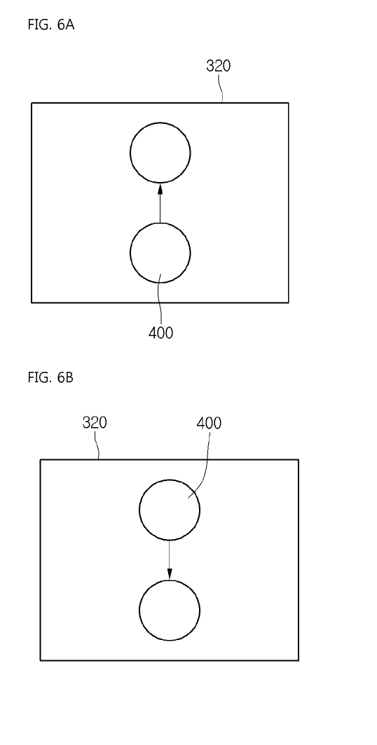

FIGS. 6A and 6B illustrate an image photographed by a camera according to a second embodiment. FIG. 6A is an image of an incoming recognized object, and FIG. 6B is a view of an image of an outgoing recognized object.

The second embodiment is the same as the first embodiment except for a method of determining an incoming or outgoing recognized object. Thus, only characterized parts in the second embodiment will be described below.

A camera 310 provided in a food storage device 101 photographs a recognized object 400. The camera 310 may photograph a moving picture or a static image several times. Hereinafter, an example in which the camera 310 photographs a static image several times will be described.

A controller 50 determines whether the recognized object 400 is stocked or released based on the photographed image.

For example, referring to FIG. 6A, the controller 50 may combine a plurality of images photographed by the camera 310 with each other to acquire one combined image 320.

Then, the controller 50 determines a moving direction of the recognized object 400 on the acquired combined image 320. For example, when a food is stocked, the recognized object 400 may move upward from a lower portion that corresponds to an opening at the side of a food storage device 101. Then, the controller 50 may determine that the recognized object 400 is stocked based on the upward movement of the recognized object 400.

On the other hand, when the food is released, the recognized object 400 may move from the upper portion towards the lower portion that corresponds to the opening of the food storage device 101. Then, the controller 50 may determine that the recognized object 400 is released based on the downward movement of the recognized object 400.

After the incoming or outgoing action of the recognized object 400 is determined by the controller 50, operations S3 and S4 of FIG. 5 may be performed, or operations S5 and S6 may be performed.

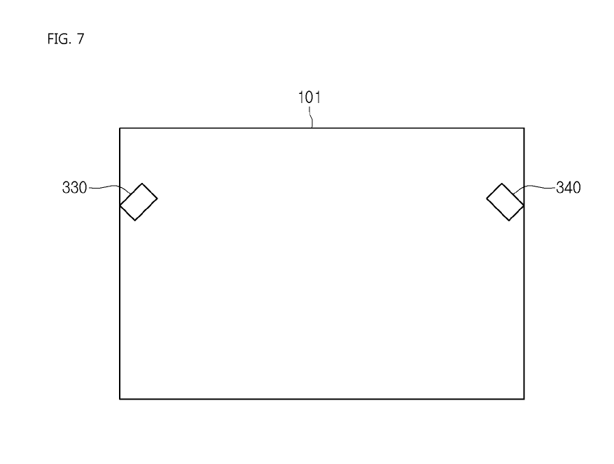

FIG. 7 is a front view of a food storage device of a refrigerator including a recognition device having a plurality of cameras, according to a third embodiment.

The third embodiment is the same as the first embodiment except for a method of determining an incoming or outgoing recognized object. Thus, only characterized parts in the third embodiment will be described below.

Referring to FIG. 7, cameras 330 and 340 may be installed on each of two opposite left and right sidewalls of a food storage device 101. That is, the first camera 330 may be disposed on the left sidewall of the food storage device 101, and the second camera 340 may be disposed on the right sidewall of the food storage device 101. Each of the cameras 330 and 340 may be disposed at an incline on the respective wall of the food storage device 101 so as to face a bottom wall of the food storage device 101. Thus, each of the cameras 330 and 340 may photograph a recognized object that is placed on the bottom wall of the food storage device 101.

Also, as illustrated in FIG. 3B, each of the cameras 330 and 340 may be disposed adjacent to an access opening of the food storage device 101.

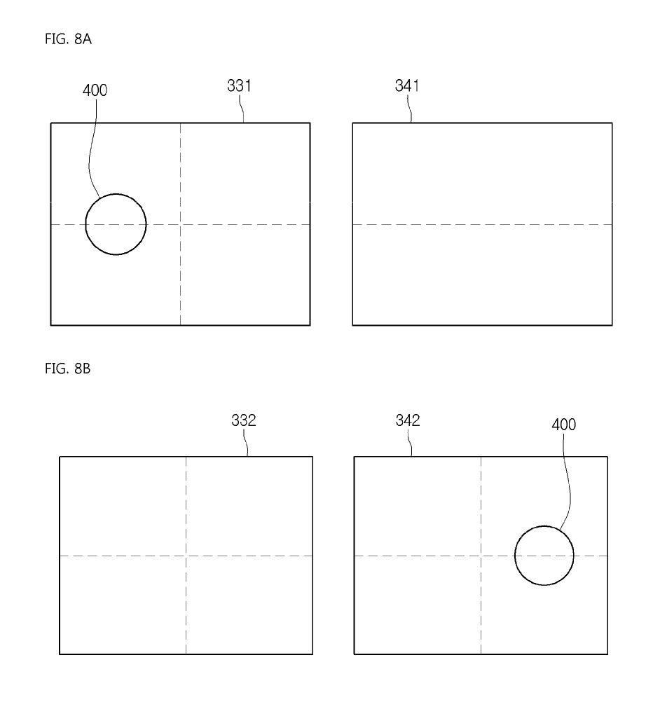

FIG. 8A illustrates images of the incoming recognized object that is photographed by the first and second cameras, and FIG. 8B illustrates images of the outgoing recognized object that is photographed by the first and second cameras. In FIGS. 8A-8B, a left image may represent an image photographed by the first camera, and a right image may represent an image photographed by the second camera.

Referring to FIGS. 7 and 8A-8B, the first and second cameras 330 and 340 provided in the food storage device 101 may photograph a front portion of the food storage device 101 to acquire images. In the current embodiment, the first and second cameras 330 and 340 may photograph the front portion of the food storage device 101 at the same time or successively photograph the front portion of the food storage device 101.

The controller 50 determines whether the recognized object 400 is stocked or released based on the images photographed by the first and second cameras 330 and 340.

For example, referring to FIG. 8A, the recognized object 400 is biased toward a left side with respect to a vertical reference line on an image 331 acquired by the first camera 330, and the object 400 does not exist on an image 341 acquired by the second camera 340.

In this case, the controller 50 may determine that the recognized object 400 is placed at a position that is biased to the left side with respect to the left and right sides of the food storage device 101, leading to the determination that the recognized object 400 is stocked.

On the other hand, referring to FIG. 8B, the recognized object 400 is not included on the image 332 acquired by the first camera 330 and is biased to a right side with respect to the vertical reference line on the image 342 acquired by the second camera 340.

In this case, the controller 50 may determine that the recognized object 400 is placed at a position that is biased to the right side with respect to the left and right sides of the food storage device 101 to determine that the recognized object is released.

After the incoming or outgoing action of the recognized object 400 is determined by the controller 50, operations S3 and S4 of FIG. 5 may be performed, or operations S5 and S6 may be performed.

However, when it is determined that the recognized object 400 is stocked, the controller 50 may extract the recognized object 400 from the image photographed by the first camera 330. However, when it is determined that the recognized object 400 is released, the controller 50 may extract the recognized object from the image photographed by the second camera 340.

Alternatively, to more accurately extract the recognized object 400, the controller 50 may generate an image of the recognized object 400 based on the image photographed by the first camera 330 and the image photographed by the second camera 340 to compare the generated image to information stored in a memory, thereby determining a food name of the recognized object.

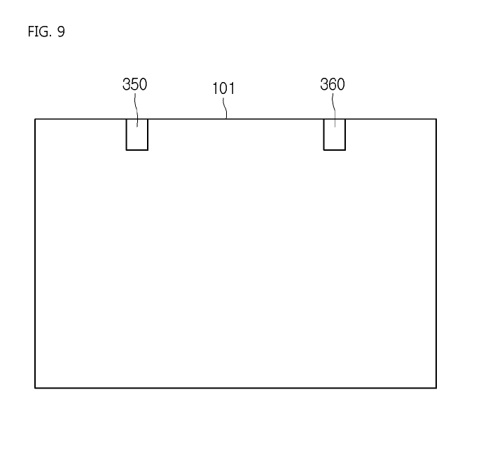

FIG. 9 is a front view of a food storage device of a refrigerator having a recognition device including a plurality of cameras, according to a fourth embodiment.

The fourth embodiment is the same as the third embodiment except for a method of determining an incoming or outgoing recognized object. Thus, only characterized parts in the fourth embodiment will be described below.

Referring to FIG. 9, a plurality of cameras 350 and 360 may be disposed on an upper wall of a food storage device 101. That is, the first camera 350 may be disposed on a left side, and the second camera may be disposed on a right side with respect to a line that bisects the upper wall of the food storage device 101. Thus, each of the cameras 350 and 360 may photograph a recognized object that is placed on the bottom wall of the food storage device 101.

Also, as illustrated in FIG. 3B, each of the cameras 350 and 360 may be disposed adjacent to an opening 110 of the food storage device 101.

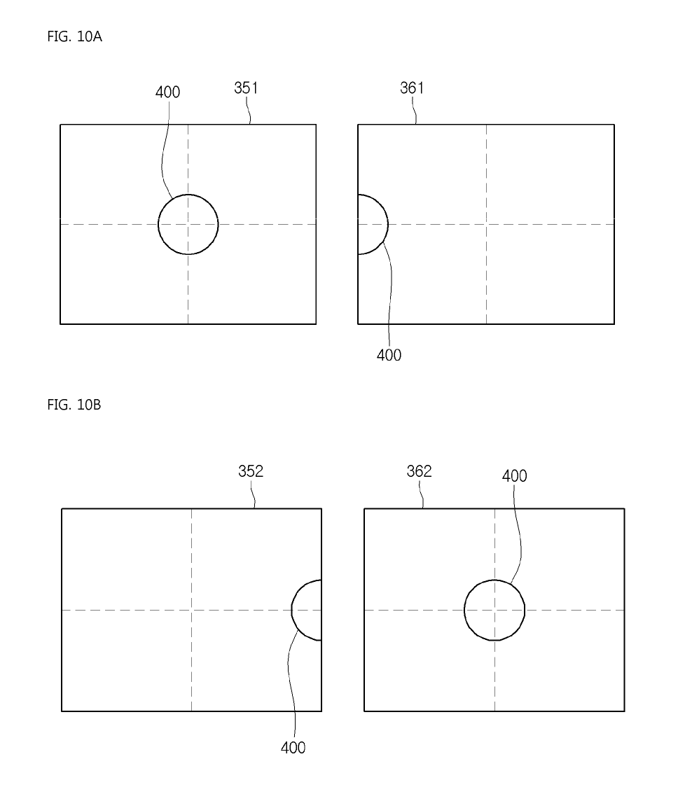

FIG. 10A is a view of images of the incoming recognized object that is photographed by the first and second cameras shown in FIG. 9, and FIG. 10B is a view of images of the outgoing recognized object that is photographed by the first and second cameras shown in FIG. 9. In FIGS. 10A-10B, a left image may represent an image photographed by the first camera, and a right image may represent an image photographed by the second camera.

Referring to FIGS. 9 and 10A-10B, the first and second cameras 350 and 360 provided in the food storage device 101 may photograph a front portion of the food storage device 101 to acquire images.

The controller 50 determines whether the recognized object 400 is stocked or released based on the images photographed by the first and second cameras 350 and 360.

For example, referring to FIG. 10A, the recognized object 400 is disposed at a center of an image 351 acquired by the first camera 350 and biased toward a left side with respect to a vertical reference line of the image 341 acquired by the second camera 340.

In this case, the controller 50 may determine that the recognized object 400 is placed on a position that is biased to the left side with respect to the left and right sides of the food storage device 101, leading to the determination that the recognized object is stocked.

On the other hand, referring to FIG. 10B, the recognized object 400 may be biased toward a right side with respect to the vertical reference line of the image 352 acquired by the first camera 350 and be disposed at a center of the image 362 acquired by the second camera 360.

In this case, the controller 50 may recognize that the recognized object 400 is placed on a position that is biased to the right side with respect to the left and right sides of the food storage device 101, leading to the determination that the recognized object is released.

After the incoming or outgoing action of the recognized object 400 is determined by the controller 50, operations S3 and S4 of FIG. 5 may be performed, or operations S5 and S6 may be performed.

To more accurately extract the recognized object 400, the controller 50 may generate an image of the recognized object 400 based on the image photographed by the first camera 350 and the image photographed by the second camera 360 to compare the generated image to information stored in a memory, thereby determining a food name of the recognized object 400.

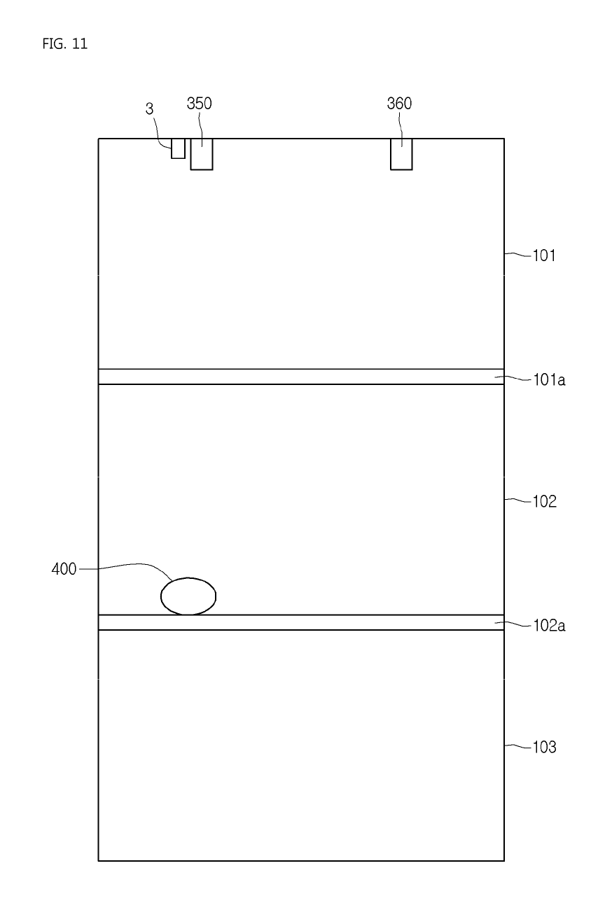

FIG. 11 is a front view of a food storage device of a refrigerator having a recognition device including a plurality of cameras, according to a fifth embodiment.

The fifth embodiment is the same as the fourth embodiment except for a method of determining a position of an incoming or outgoing recognized object. Thus, only characterized parts in the fifth embodiment will be described below.

Referring to FIG. 11, a refrigerator 10 may include a plurality of food storage devices 101, 102, and 103, or storage chambers 101, 102 and 103. For example, although three food storage devices 101, 102, and 103 are provided in the current embodiment, the current embodiment is not limited to this number of food storage devices.

First and second cameras 350 and 360 may be disposed at an upper wall of the uppermost (first) food storage device 101 of the plurality of food storage devices 101, 102, and 103.

For example, the plurality of food storage devices 101, 102, and 103 may be partitioned by shelves 101a and 102a on which a food item is placed. At least front portion of each of the shelves 101a and 102a may be transparent. That is, a portion of the shelves 101a and 102a may be transparent so that the cameras 350 and 360 disposed on the first food storage device 101 may also photograph an object that is placed on the second shelf 102a or the bottom wall of the third food storage device 103.

At least one distance sensor 3 may be provided in the first food storage device 101 to detect a distance to a food item. The distance sensor 3 may measure a distance from the incoming or outgoing food, and the controller 50 may determine a position of a food storage device corresponding to the incoming or outgoing food based on the distance measured by the distance sensor 3.

For example, the distance sensor 3 may be an ultrasonic sensor. However, the current embodiment is not limited to a particular type of distance sensor 3.

Thus, according to the current embodiment, the food stocked into or released from each of the plurality of food storage devices may be determined, and also, a position of the incoming or outgoing food may be precisely determined.

Although the incoming or outgoing food is identified and tracked using the separate distance sensor in the foregoing embodiment, the present disclosure is not limited thereto. For example, a distance between one camera of the plurality of cameras and the food may be estimated using stereo matching which estimates a distance by comparing images of the food item captured by the plurality of cameras to each other. Then, a position of the incoming or outgoing food may be determined based on the estimated distance.

Also, information displayed on the display 20 of the refrigerator 10 may be transmitted to the display 82 of the terminal 80 and then confirmed on the terminal 80.

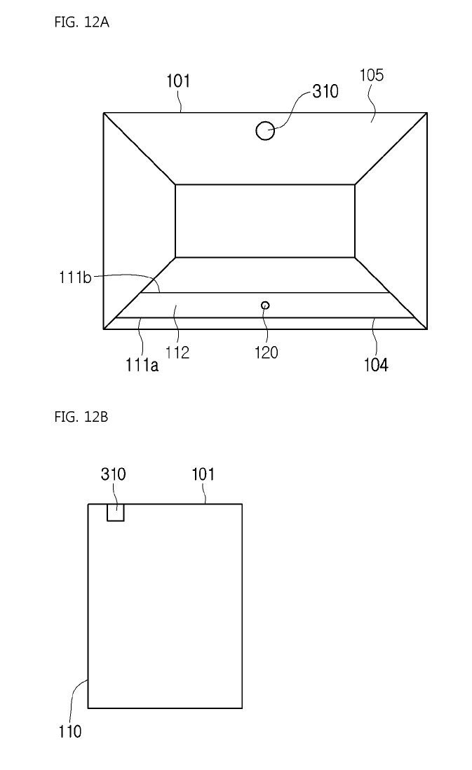

FIG. 12A is a front view of a food storage device, and FIG. 12B is a side view of the food storage device shown in FIG. 12A, in accordance with a sixth embodiment.

The current embodiment is the same as the first embodiment except for a method of stocking or releasing food items. Thus, only characterized parts in the current embodiment will be described below.

A reference area 112 for photographing an image of an incoming or outgoing food item may be defined at a front portion of a lower wall 104 of a food storage device 101. For example, reference lines 111a and 111b for defining the reference area 112 may be disposed on the lower wall 104 of the food storage device 101. The reference lines 111a and 111b may extend horizontally and include two lines that are parallel to each other along the lower wall 104. That is, the reference lines 111a and 111b may include a first line 111a and a second line 111b that is disposed to a rear of the first line 111a, in parallel to the first line 111a. An area between the first line 111a and the second line 111b may be defined as the reference area 112.

In certain embodiments, the reference lines 111a and 111b may be attached to the lower wall 104 of the food storage device 101 or painted on the lower wall 104. Alternatively, the reference lines 111a and 111b may be defined by front and rear edges of a protrusion formed along a portion of the lower wall 104 of the food storage device 101 or front and rear edges of a recess formed a portion of the lower wall 104.

For another example, the reference area 112 may have a polygonal shape, e.g., a square shape, to provide at least four reference lines. For another example, the reference area 112 may have a curved shape such as a circular or oval shape. In this case, the reference area 112 may be defined by one continuous reference line. The current embodiment is not limited to these specific shapes for the reference area.

A camera 310 may photograph an area including the reference area 112 on the lower wall 104 of the food storage device 101. That is, an image photographed by the camera 310 may include at least the reference area 112.

A sensor 120 for detecting a recognized object 400 may be provided on a position corresponding to the reference area 112. For example, the sensor 120 may be disposed on the lower wall 104 of the food storage device 101. That is, the sensor 120 may be disposed on a wall of the food storage device 101 facing the wall on which the camera 310 is disposed, but is not limited thereto.

Alternatively, the sensor 120 may be disposed on an upper wall 105 of the food storage device 101. The sensor 120 may be disposed on a portion of the upper wall 105 that faces the reference area 112 on the lower wall 104.

Alternatively, the sensor 120 may be disposed on one or both both side surfaces of the food storage device 101, at a position corresponding to the reference area 112.

That is, the sensor 120 may be disposed to detect the recognized object 400 disposed on the reference area 112 or, additionally/alternatively, a user's hand. The sensor 120 may detect the food or the user's hand, the current embodiment is not limited to a specific type of sensor 120.

For another example, a controller 50 may determine movement of the recognized object 400 or the user's hand based on a signal output from the sensor 120, and may then control the camera 310 in response to the signal.

For example, when the food is placed and stored on the reference area 112, since the sensor 120 detects the food item in a static state, a detection signal may be output from the sensor 120 for a predetermined time. In this case, the controller 50 may determine that the recognized object 400 or the user's hand does not move, and prevent the camera 310 from operating.

The controller 50 may determine a name of the food corresponding to the recognized object 400 based on the image photographed by the camera 310. Also, the controller 50 may determine whether the food is stocked or released based on the image photographed by the camera 310.

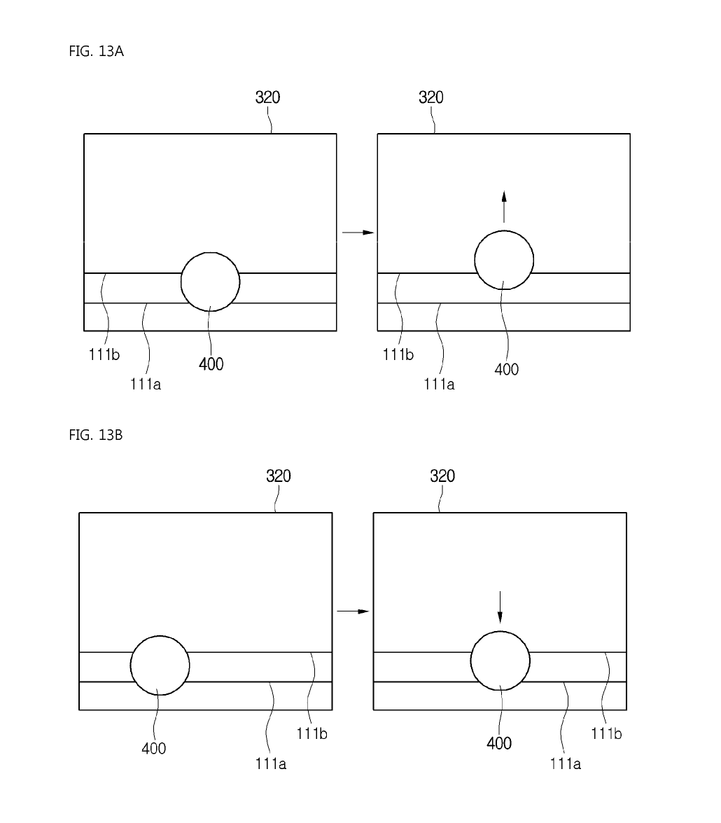

FIG. 13A is a view of a photographed image of the incoming food, and FIG. 13B is view of a photographed image of the outgoing food, in accordance with the embodiment shown.

A camera 310 provided in a food storage device 101 photographs a recognized object 400. The camera 310 may be maintained in a standby state, so that when the sensor 120 detects a food item in the reference area 112, the camera 310 may photograph the food. Alternatively, when the sensor 120 detects a food item, the camera 310 may photograph the food item after a predetermined time has elapsed.

As described above, since the camera 310 operates when the sensor 120 detects a food item that is disposed on the reference area 112, unnecessary power consumption may be avoided and the camera 310 may acquire the whole image of the food. For example, the camera 310 may acquire a plurality of food images by photographing the food several times.

Also, when the sensor 120 detects a food item disposed on the reference area 112, the camera 310 may automatically operate, without a manual user command, enhancing user convenience.

Also, a controller 50 determines whether the recognized object 400 is stocked or released based on the photographed image. The controller 50 determines whether the recognized object 400 is stocked or released through a variation in state in which the recognized object 400 and the plurality of reference lines 111a and 111b overlap on the image photographed by the camera 310.

For example, referring to FIG. 13A, a first image 320 (a left image) photographed by the camera 310 may include the plurality of reference lines 111a and 111b and the recognized object 400. As shown, the reference lines 111a and 111b may both overlap the recognized object 400.

A second image (a right image) photographed by the camera 310 may include the plurality of reference lines 111a and 111b and the recognized object 400. However, now a portion of the reference lines 111a and 111b, for example, only the reference line that is at a relatively move interior position (i.e., the reference line 111b) may overlap the recognized object 400.

The controller 50 may determine that the recognized object is stocked base only the more interior reference line 111b of the plurality of reference lines 111a and 111b overlaps the recognized object 400 in the second image, after both of the reference lines 111a and 111b overlapped the recognized object 400 in the first image.

Now, referring to FIG. 13B, the first image 320 (the left image) photographed by the camera 310 may include the plurality of reference lines 111a and 111b and the recognized object 400. Here, both reference lines 111a and 111b may overlap the recognized object 400, or only the more interior reference line 111b overlaps the object 400.

The second image 320 (right) photographed by the camera 310 may include the plurality of reference lines 111a and 111b and the recognized object 400. Here, a portion of the reference lines 111a and 111b, for example, only the reference line that is at a relatively outer position (i.e., the reference line 111a) may overlap the recognized object 400.

The controller 50 may determine that the recognized object is released because only the outer reference line 111a of the plurality of reference lines 111a and 111b overlaps the recognized object 400 in the second image, after both of the reference lines 111a and 111b overlapped the recognized object 400 in the first image.

If the controller 50 determines that the recognized object corresponds to an incoming food item, the controller 50 extracts the recognized object 400 from the photographed image to compare an image of the extracted recognized object 400 to the image stored in the memory 40, thereby determining a food name corresponding to the image of the extracted recognized object 400.

For another example, the controller 50 may transmit the image of the extracted recognized object 400 to the server and compare the image of the extracted recognized object 400 to the image stored in the memory of the server, and the server may transmit the food name to the controller.

Then, the controller 50 may store information with respect to the extracted food name in the memory 40 to display the information with respect to the extracted food name on the display 20.

For example, the controller 50 may control the memory 40 and the display 20 to store the extracted food name and an image corresponding to the extracted food name, a stored position of the incoming food, an incoming date of the food, a residual period for storing the incoming food, a storage method, and the like in the memory 40, and may display at least one of the items of information stored in the memory 40 on the display unit 20.

The memory 40 may include a first memory for storing the food related information and a second memory for storing the extracted food name (the incoming food name).

If the controller 50 determines that the recognized object 400 corresponds to an outgoing food item, the controller 50 extracts the recognized object 400 from the photographed image to compare an image of the extracted recognized object 400 to the image stored in the memory 40 (or the memory of the server 70), thereby determining a food name corresponding to the image of the extracted recognized object 400.

Then, the controller 50 may delete the information with respect to the name of the extracted food from the memory 40 and display the outgoing food name on the display 20.

For example, the information with respect to the released food name may be deleted from the second memory, and the image corresponding to the released food name, the stored position of the released food, the incoming date of the food, the residual period for storing the incoming food, and the like may be displayed on the display 20.

When modification of the information with respect to the stocked food and the information with respect to the released food, which are displayed on the display 20, is needed, the user may select the information to be modified and then modify the selected information.

According to the current embodiment, the incoming or outgoing of the food that is the recognized object may be clearly recognized, and also, the food name of the food that is the recognized object may be clearly recognized.

Although the camera acquires the image (the static image) several times in the foregoing embodiment, the current embodiment is not limited thereto. For example, the camera may photograph a moving picture.

Also, although the camera acquires the image (the static image) several times in the current embodiment, the current embodiment is not limited thereto. For example, the controller 50 may determine whether the food is stocked or released based on the relative positions of the reference lines within the acquired image and the recognized object 400.

For example, when the food is stocked, the first line 111a and the recognized object 400 may overlap each other. Also, when the food is released, the second line 111b and the recognized object 400 may overlap each other. Also, even though the recognized object and the plurality of reference lines overlap each other, the controller may compare a front and rear length of the recognized object and the relative positions of the reference lines to determine whether the food is stocked or released.

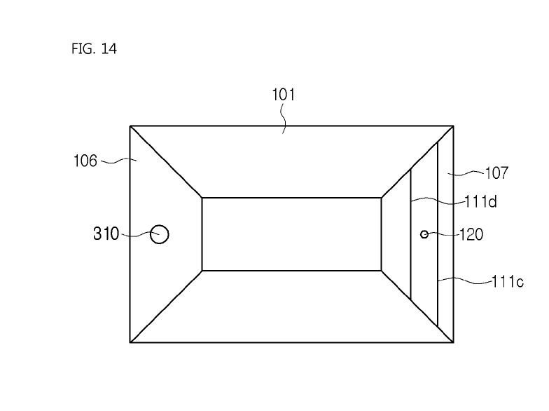

FIG. 14 is a view of a state in which a recognition device including a camera is installed on one of two opposite sidewalls of a food storage device according to a seventh embodiment.

The seventh embodiment is the same as the sixth embodiment except that a camera is disposed on a reference area. Thus, only characterized parts in the sixth embodiment will be described below.

Referring to FIG. 14, a camera 310 is disposed on a first of two opposite sidewalls 106 and 107 of a food storage device 101. Referring to FIG. 14, although the camera 310 is disposed on a left sidewall of the food storage device 101, the current embodiment is not limited thereto.

The reference area may be defined on a second wall (e.g., a right wall 107 of the food storage device 101) facing the first wall on which the camera 310 is disposed. Also, a sensor 120 may be disposed on the second wall, facing the first wall on which the camera 310 is disposed. The reference area as described in the previous embodiment may be defined by reference lines 111c and 111d.

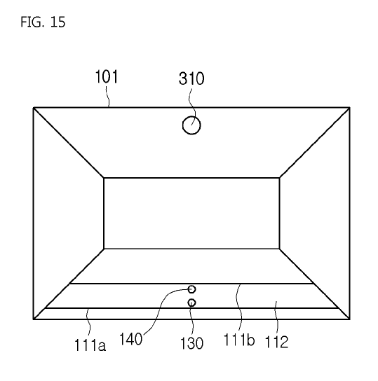

FIG. 15 illustrates a food storage device having a recognition device including a plurality of sensors and a camera, according to an eighth embodiment.

The eighth embodiment is the same as the sixth embodiment except for a number of sensors. Thus, only characterized parts in the eighth embodiment will be described below.

Referring to FIG. 15, a plurality of sensors 130 and 140 are disposed on a wall on which a reference area 112 is defined. The plurality of sensors 130 and 140 may be disposed spaced apart from each other in front and rear directions of the storage device 101.

The plurality of sensors 130 and 140 may be disposed within the reference area 112.

A controller 50 may operate the camera 310 when a recognized object 400 is detected by one of the plurality of sensors 130 and 140. Also, the controller 50 may determine whether the recognized object 400 is stocked or released based on the recognized order of the recognized object 400 by the plurality of sensors 130 and 140.

In one embodiment, an electric product as embodied and broadly described herein may include a main body including at least one food storage unit; at least one camera disposed in the at least one food storage unit to photograph an incoming or outgoing food; and a control unit to determine whether the food is stocked or released on the basis of an image photographed by the at least one camera.

In another embodiment, an electric product as broadly described herein may include a main body including a food storage unit; at least one camera disposed in the food storage unit to photograph an incoming or outgoing food; and a control unit determining whether the food is stocked or released on the basis of an image photographed by the at least one camera, wherein a reference area defined by a reference line is defined on one sidewall of the food storage unit, the photographed image includes the reference line, and the control unit that determines whether the food is stocked or released on the basis of positions of the reference line and the food within the photographed image.

In still another embodiment, an electric product as broadly described herein may include a main body including a food storage unit; at least one camera disposed in the food storage unit to photograph an incoming or outgoing food; and a sensor disposed on the food storage unit to detect the food; and a control unit that operates the at least one camera on the basis of information detected by the sensor, the control unit determining whether the food is stocked or released on the basis of the image photographed by the at least one camera.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A storage device, comprising:
a main body comprising at least one storage chamber;
at least one camera disposed in the at least one storage chamber to photograph incoming and outgoing storage items; and
a controller configured to determine whether a storage item is stocked in the at least one storage chamber or released from the at least one storage chamber based on an image photographed by the at least one camera.

2. The device of claim 1, wherein the controller is configured to extract an image of the storage item from the image photographed by the at least one camera to determine a name corresponding to the storage item.

3. The device of claim 2, further comprising a memory that stores a plurality of images to be compared with the extracted image of the storage item.

4. The device of claim 3, wherein the memory stores information related to storage items currently stocked in the at least one storage chamber, and the controller stores information related to storage items in the memory as they are stocked and displays the information on a display when the controller determines that the storage items are stocked.

5. The device of claim 3, wherein the memory stores information related to storage items that are currently stocked in the at least one storage chamber, and the controller is configured to delete the information related to released storage items from the memory and to display the information on the display when the controller determines that storage items are released from the at least one storage chamber.

6. The device of claim 1, wherein the at least one camera is disposed on an upper wall or a lateral side wall of the at least one storage chamber, at a position adjacent to an access opening into the at least one storage chamber.

7. The device of claim 1, wherein the controller is configured to determine whether the storage item is stocked or released based on a position of the storage item in the image photographed by the at least one camera.

8. The device of claim 7, wherein the controller is configured to divide the photographed image into a plurality of areas, and the controller is configured to determine whether the storage item is stocked or released based on the position of the storage item in one or more of the plurality of areas of the photographed image.

9. The device of claim 1, wherein the at least one camera comprises a plurality of cameras provided in the at least one storage chamber, and the controller is configured to determine whether the storage item is stocked or released based on a plurality of images photographed by the plurality of cameras.

10. The device of claim 9, wherein the controller is configured to estimate a distance between the storage item and one of the plurality of cameras based on the plurality of images photographed by the plurality of cameras and to determine a position of the incoming or outgoing storage item based on the estimated distance.

11. The device of claim 9, wherein the at least one storage chamber comprises a plurality of storage chambers formed in the main body, wherein the device further comprises:
a distance sensor provided in at least one of the plurality of storage chambers and configured to measure a distance between the plurality of cameras and the storage item; and
a transparent shelf provided between adjacent storage chambers of the plurality of storage chambers to partition the plurality of storage chambers,
wherein the controller is configured to determine whether the storage item is stocked or released based on the plurality of images photographed by the plurality of cameras, and to determine a position of the incoming or outgoing storage item based on the detected distance.

12. The device of claim 1, wherein the controller is configured to determine a moving direction of the storage item from the image photographed by the at least one camera, and to determine whether the storage item is stocked or released based on the determined moving direction.

13. The device of claim 12, wherein the at least one camera is configured to capture a moving image, and the controller is configured to determine the moving direction of the storage item from the moving image captured by the at least one camera.

14. The device of claim 12, wherein the at least one camera is configured to capture a plurality of static images at predetermined intervals, and the controller is configured to generate a combined image from the plurality of static images to determine the moving direction of the storage item from the combined image.

15. The device of claim 1, further comprising a sensor disposed in the at least one storage chamber to detect the storage item, wherein the controller is configured to operate the at least one camera based on information detected by the sensor.

16. The device of claim 15, wherein the at least one camera is configured to photograph a reference area defined on a first side wall of the at least one storage chamber.

17. The device of claim 16, wherein the sensor is disposed on the first side wall of the at least one storage chamber, on which the reference area is also defined.

18. The device of claim 16, wherein the sensor and the at least one camera are disposed facing each other, on opposite walls of the at least one storage chamber.

19. The device of claim 16, wherein the sensor is disposed within the reference area or at a position corresponding to the reference area.

20. The device of claim 16, wherein the sensor comprises a plurality of sensors disposed on the at least one storage chamber, spaced apart from each other at a front end of the at least one storage chamber, and the controller is configured to operate the at least one camera based on information detected by the plurality of sensors and to determine whether the storage item is stocked or released based on the information detected by the plurality of sensors.

21. The device claim 16, wherein the reference area is defined by at least one reference line, and the controller is configured to determine whether the storage item is stocked or released based on a relative position of the at least one reference line and the storage item captured within the image photographed by the at least one camera.

22. A refrigerator comprising the storage device of claim 1.

23. A storage device in which a plurality of storage items are stocked into and released from, the device comprising:
a main body comprising at least one storage device;
at least one camera disposed in the at least one storage chamber to photograph incoming and outgoing storage items;
a reference area defined by at least one line on a first side wall of the at least one storage chamber; and
a controller configured to determine whether a storage item is stocked or released based on an image photographed by the at least one camera, wherein the photographed image includes the at least one reference line, and the controller is configured to determine whether the storage item is stocked or released based on relative positions of the at least one reference line and the storage item within the photographed image.

24. An electric product in which storage items are stocked into and released from, comprising:
a main body comprising at least one storage chamber;
at least one camera disposed in the at least one storage chamber to photograph incoming and outgoing storage items;
a sensor disposed on the at least one storage chamber to detect the storage items; and
a controller configured to operate the at least one camera based on information detected by the sensor, the controller determining whether the storage items are stocked into or released from the at least one storage chamber based on the image photographed by the at least one camera.
